(19) United States
(12) Patent Application Publication
(10) Pub. No.: US 2025/0122363 A1
(43) Pub. Date: Apr. 17, 2025

(54) PAINT CHAR FILLED POLYMER COMPOSITES AND METHODS OF MAKING THEREOF

(71) Applicants: University of Guelph, Guelph (CA); Ford Global Technologies, LLC, Dearborn, MI (US)

(72) Inventors: Amar K. Mohanty, Guelph (CA); Manjusri Misra, Guelph (CA); Neelima Tripathi, Guelph (CA); Arturo Rodriguez, Guelph (CA); Michael Snowdon, Guelph (CA); Deborah Frances Mielewski, Ann Arbor, MI (US); Alper Kiziltas, Sarikamis (TR)

(73) Assignees: University of Guelph, Guelph (CA); Ford Global Technologies, LLC, Dearborn, MI (US)

(21) Appl. No.: 18/485,851

(22) Filed: Oct. 12, 2023

(51) Int. Cl. C08K 11/00; C08J 3/20; C08L 23/12; C09K 21/02

(52) U.S. Cl. CPC C08K 11/005; C08J 3/203; C08L 23/12; C09K 21/02; C08J 2323/12; C08J 2497/00; C08L 2201/02

(57) ABSTRACT

A composite material includes a polymer and a paint char material. The paint char material includes pyrolyzed paint sludge and in some forms is a hybrid paint char. The hybrid paint char includes lignin.

### FIELD

The present disclosure relates to polymer composites and methods of making polymer composites.

### BACKGROUND

The statements in this section merely provide background information related to the present disclosure and may not constitute prior art.

A common problem found with composites that use large contents of fillers such as talc or glass fiber, is the density and weight increase that arises. Likewise, the inclusion of certain fillers can cause electrical conductivity variations that hinder their use in a variety of applications.

Automobile manufacturing is a prominent sector that continues to grow with passenger vehicle production. As a result of the increasing output of cars, disposal of waste within the manufacturing facilities is becoming a larger concern. The main source of waste in this sector is automotive paint sludge which makes up approximately 40% of the paint used during spraying operations. This material is commonly disposed of through landfilling or incineration. One way to reduce the economic disposal issues and find a secondary life for this waste stream material is to adapt it into a byproduct. This can be accomplished through pyrolytic processes to form char that can be incorporated into plastic composites for reinforcing and property enhancement.

Although present methods of producing char filled polymer composites have achieved their intended purposes, new methods of making char filled polymer composites are desired. Certain issues related to making char filled polymer composites are addressed in the present disclosure.

### SUMMARY

This section provides a general summary of the disclosure and is not a comprehensive disclosure of its full scope or all of its features.

In one form, the present disclosure provides a composite material having a polymer and a paint char material. The paint char material includes pyrolyzed paint sludge.

In variations of this composite material, which may be implemented individually or in any combination: the polymer is selected from the group comprising polypropylene, polyamide, poly (ethylene terephthalate), acrylonitrile butadiene styrene, and polycarbonate; the paint char material content is 5-30 wt %; the composite material has a tensile strength greater than or equal to 30 MPa; the composite material has an impact strength of greater than 20 J/m; the composite material has a density between 0.8 and 1.5 g/cc; and the composite material has a linear burning rate less than 10 mm/min.

The present disclosure further provides a composite material having a polymer and a hybrid paint char material. The hybrid paint char material includes a pyrolyzed mixture of paint sludge and lignin.

In variations of this composite material, which may be implemented individually or in any combination: the polymer is selected from the group comprising polypropylene, polyamide, poly (ethylene terephthalate), acrylonitrile butadiene styrene, and polycarbonate; the paint sludge is automotive paint waste; the composite material has a tensile strength greater than or equal to 30 MPa; the composite material has a density between 0.8 and 1.5 g/cc; and the composite material has a linear burning rate less than 10 mm/min.

In yet another form, the present disclosure provides a method of manufacturing a polymer composite material. The method includes drying a paint char material, mixing the paint char material with a polymer, and compounding the mixture of the paint char material and the polymer.

In variations of this composite material, which may be implemented individually or in any combination: the polymer is selected from the group comprising polypropylene, polyamide, poly (ethylene terephthalate), acrylonitrile butadiene styrene, and polycarbonate; the paint char material comprises a pyrolyzed paint sludge; the paint char material comprises a pyrolyzed mixture of paint sludge and lignin; the paint char material comprises a pyrolyzed automotive paint sludge; the composite material has a linear burning rate less than 10 mm/min; and the composite material is 5-30 wt % paint char.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a composite material according to the present disclosure;

FIG. 2 is a flow diagram illustrating a method of manufacturing a paint char filled polymer composite; and

FIG. 3 is a chart illustrating electrical conductivity vs pressure for different samples.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

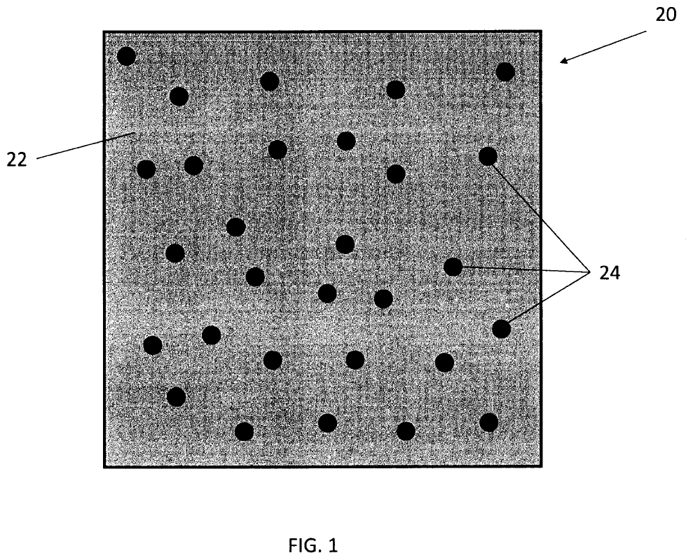

Referring to FIG. 1, a polymer composite is generally illustrated by reference numeral 20. The composite material 20 includes a polymer 22 and a paint char material 24.

The polymer 22 forms a matrix for the composite 20. In some forms the polymer 22 is polypropylene, polyamide, poly (ethylene terephthalate), acrylonitrile butadiene styrene, polycarbonate, or a combination of materials. However, other polymers may be utilized within the scope of the present disclosure.

The paint char material 24 is a recycled material manufactured from paint sludge. It acts as a filler in place of conventional fillers such as talc. In some forms, the paint char material is 5-30% by weight of the composite. In some forms, the paint char material is a powder.

In some forms, the paint char material 24 is pyrolyzed paint sludge, which may be automotive paint sludge. As used herein, paint sludge is a waste paint byproduct of painting. Paint sludge is a complex mixture of uncured polymer resins, binders, solvents, pigments, additives, and water. During the pyrolysis process, the organic substances in the paint sludge are at least partially thermochemically converted into solid carbon in an oxygen-limited environment.

In other forms, the paint char material may be a hybrid material. The hybrid material is a pyrolyzed mixture of paint sludge and lignin.

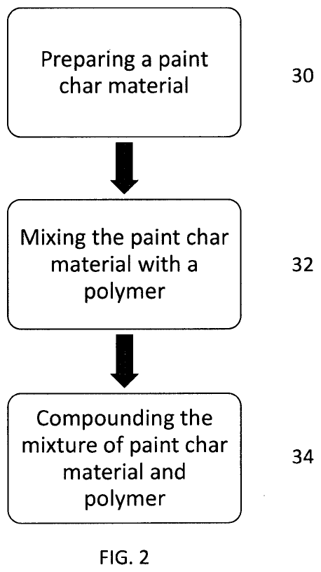

With reference to FIG. 2, a flow diagram illustrating a process for manufacturing the composite material is shown. The process begins as shown in block 30, in which a paint char material is prepared by pyrolysis. Next, in block 32, the paint char material is mixed with a polymer. Finally, the mixture of paint char material and polymer is compounded. In some forms, the mixture is compounded in a screw compounder. Optionally, the compounded mixture may be molded to create a variety of shapes for different applications.

### Example 1: Preparation of Polypropylene (PP)-Based Composite Compositions

Example 1A. Composite was prepared containing 70 wt. % PP and 30 wt. % hybrid paint char. The hybrid char was prepared by pyrolyzing at 1000° C. followed by 60 h ball-milling. The blend was extruded in a DSM Micro 15 cc twin screw compounder, with a 190° C. extrusion temperature, a 100 RPM screw speed, and a 2-minute retention time. The material was molded using a DSM micro 12 cc mini-injection molder. Both injection and holding time was set to 7 seconds.

Example 1B. Composite was prepared containing 60 wt. % PP (1120H), 30 wt. % hybrid paint char, 50 wt. %, 7 wt. % POE-g-MA, and 3 wt. % maleic anhydride grafted. The hybrid paint char was prepared by pyrolyzing at 500° C. followed by 1 h ball-milling. The blend was extruded in a DSM Micro 15 cc twin screw compounder, with a 200° C. extrusion temperature, a 100 RPM screw speed, and a 2-minute retention time. The material was molded using a DSM micro 12 cc mini-injection molder. Both injection and holding time was set to 7 seconds.

### Example 2: Preparation of Polyethylene Terephthalate (PET)-Based Composite Compositions

Example 2A. Composite was prepared containing 30 wt. % hybrid paint char with 70 wt. % consisting of 85 wt. % PET (Laser+B90A): recycled PET (LNO P) (50:50 wt. %), 15 wt. % POE-g-MA (Fusabond N493) and 1 phr Joncryl (ADR 4468). The hybrid paint char was prepared by pyrolyzing at 500° C. followed by 1 h ball-milling. The blend was extruded in a DSM Micro 15 cc twin screw compounder at 270° C., a 100 RPM screw speed, and a 2-minute retention time. The material was molded using a DSM micro 12 cc mini-injection molder. Both injection and holding time was set to 10 seconds.

### Example 3: Preparation of Polycarbonate (PC)-Based Composite Compositions

Example 3A. Composite was prepared containing 7 wt. % paint char and remaining 93 wt. % consists of 62 wt. % recycled PC, 32 wt. % poly (lactic acid), 6 wt. % poly (ethylene n-butylene-acrylate glycidyl methacrylate) and 0.3 phr Joncryl (ADR 4468). The paint char was prepared by pyrolyzing at 500° C. followed by 1 h ball-milling. The blend was extruded in a DSM Micro 15 cc twin screw compounder, with a 270° C. extrusion temperature, a 100 RPM screw speed, and a 2-minute retention time. The material was molded using a DSM micro 12 cc mini-injection molder. Both injection and holding time was set to 7 seconds.

Example 3B. Composite was prepared containing 7 wt. % hybrid paint char and remaining 93 wt. % consists of 62 wt. % recycled PC, 32 wt. % poly (lactic acid), 6 wt. % EBAGMA, and 0.3 phr Joncryl (ADR 4468). The hybrid paint char was prepared by pyrolyzing at 500° C. followed by 1 h ball-milling. The blend was extruded in a DSM Micro 15 cc twin screw compounder, with a 270° C. extrusion temperature, a 100 RPM screw speed, and a 2-minute retention time. The material was molded using a DSM micro 12 cc mini-injection molder. Both injection and holding time was set to 7 seconds.

### Example 4: Preparation of Polycarbonate/Acrylonitrile Butadiene Styrene (PC/ABS) Based Composite Compositions

Example 4A. Composite was prepared containing 27 wt. % hybrid paint char, 3 wt. % recycled carbon fibers and remaining 70 wt. % consists of 61 wt. % recycled PC (OPTICARB 1614): ABS (Magnum 1150 EM) (50:50 wt. %), 30 wt. % PLA (3251 D), 6 wt. % EBAGMA (Elvaloy PTW), 3 wt. % lubricant (Plastistrength L1000) and 0.3 phr Joncryl (ADR 4368). The hybrid paint char was prepared by pyrolyzing at 500° C. followed by 1 h ball-milling. The blend was extruded in a DSM Micro 15 cc twin screw compounder, with a 270° C. extrusion temperature, a 100 RPM screw speed, and a 2-minute retention time. The material was molded using a DSM micro 12 cc mini-injection molder. Both injection and holding time was set to 7 seconds.

Specimens of the described Examples 1A-4A were tested for a variety of properties, with the results shown in Table 2. All tests used ASTM standard test specimens (tensile dog-bone type IV samples according to ASTM D638, flexural bars according to ASTM D790, notched Izod impact bars according to ASTM D256, and heat deflection temperature bars according to ASTM D648). All composites containing APS char, or its hybrid variant demonstrated mechanical and thermo-mechanical properties consistent for a mineral filled composite at the loading level described herein.

TABLE 1
Mechanical Properties of Polymers and Automotive Paint Sludge (APS) Char-based Composites

| | | | | | | | | HDT | | |
|---|---|---|---|---|---|---|---|---|---|---|
| | Tensile | Tensile | % | % | Flexural | Flexural | Impact | (° C.) | | |
| | Strength | Modulus | Elongation | Elongation | Strength | Modulus | Strength | (at 0.455 | MFI | Density |
| Example | (MPa) | (MPa) | at yield | at break | (MPa) | (MPa) | (J/m) | MPa) | (g/10 min.) | (g/cc) |
| 1A | 32.0 ± | 3113 ± | 3.01 ± | 4.79 ± | 56.26 ± | 3012 ± | 23.61 ± | 126.89 ± | 10.2 ± | 1.037 ± |
| | 0.10 | 271 | 0.1 | 0.71 | 4.14 | 392 | 1.64 | 0.93 | 0.85 | 0.004 |
| | | | | | | | | | (230° C./ | |
| | | | | | | | | | 2.16 kg) | |
| 1B | 30.5 ± | 2031 ± | 4.71 ± | 7.57 ± | 57.65 ± | 2425 ± | 29.84 ± | 112.79 ± | 112.66 ± | 0.9894 ± |
| | 0.63 | 87 | 0.1 | 0.68 | 2.18 | 123 | 1.93 | 0.18 | 0.18 | 0.0034 |
| | | | | | | | | | (230° C./ | |
| | | | | | | | | | 2.16 kg) | |
| 2A | 37.0 ± | 2521 ± | 2.91 ± | 5.72 ± | 68.14 ± | 2930 ± | 30.39 ± | 72.36 ± | — | 1.271 ± |
| | 0.77 | 129 | 0.1 | 0.44 | 1.80 | 120 | 2.69 | 0.2 | | 0.002 |
| 3A | 54.9 ± | 2762 ± | 3.9 ± | 54 ± | 85.59 ± | 2688 ± | 92.80 ± | 130 | 45 ± | 1.2 ± |
| | 0.3 | 78 | 0.1 | 18 | 0.60 | 3.6 | 3.46 | | 2 | 0.002 |
| | | | | | | | | | (300° C./ | |
| | | | | | | | | | 1.2 kg) | |
| 3B | 57.3 ± | 2685 ± | 4.01 ± | 12.94 ± | 93.54 ± | 2939 ± | 91.24 ± | 134.47 ± | 27.2 ± | 1.168 ± |
| | 1.19 | 226 | 02 | 4.32 | 3.34 | 1523 | 4.63 | 0.07 | 1.13 | 0.004 |
| | | | | | | | | | (300° C./ | |
| | | | | | | | | | 1.2 kg) | |
| 4A | 468. ± | 4863 ± | 1.03 ± | 1.41 ± | 65.31 ± | 4773 ± | 23.1 ± | 101.92 ± | — | 1.1946 ± |
| | 2.06 | 158 | 0.7 | 0.09 | 4.08 | 346 | 2.45 | 3.76 | | 0.002 |

The flammability characteristics (following ASTM D635) of the composite specimens are shown in Table 2. The incorporation of the APS char or its hybrid variant provided increased flammability resistance compared to a talc alternative. The linear burning rate was reduced by up to 72% for the APS char containing sample relative to the talc composite.

TABLE 2
Flammability Comparison of PP and Composites
(ASTM D635)

| | Linear | UL 94 |
|---|---|---|
| | Burning Rate | Flammability |
| Sample | (mm/min) | Rating |
| Polypropylene (PP) | 20.2 ± 0.3 | HB |
| PP + 30% Talc | 30.4 ± 1.5 | HB |
| PP + 30% APS Char | 8.6 ± 0.2 | HB |
| PP + 30% APS Hybrid Char | 24.7 ± 0.9 | HB |

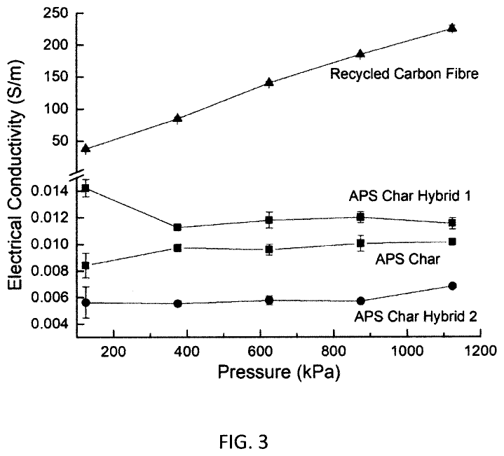

In FIG. 3, the electrical conductivity of the APS char and APS hybrid char particulate/powder material is compared to recycled carbon fiber. With the low electrical conductivity, the APS char and APS hybrid char material acts as an insulator that will maintain the insulating performance of the polymeric composite for use in non-conductive material applications.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A composite material comprising:
a polymer; and
a paint char material,
the paint char material comprising pyrolyzed paint sludge.

2. The composite material of claim 1, wherein the polymer is selected from the group comprising polypropylene, polyamide, poly (ethylene terephthalate), acrylonitrile butadiene styrene, and polycarbonate.

3. The composite material of claim 1, wherein the paint char material content is 5-30 wt %.

4. The composite material of claim 1, wherein the composite material has a tensile strength greater than or equal to 30 MPa.

5. The composite material of claim 1, wherein the composite material has an impact strength of greater than 20 J/m.

6. The composite material of claim 1, wherein the composite material has a density between 0.8 and 1.5 g/cc.

7. The composite material of claim 1, wherein the composite material has a linear burning rate less than 10 mm/min.

8. A composite material comprising
a polymer; and
a hybrid paint char material,
the hybrid paint char material comprising a pyrolyzed mixture of paint sludge and lignin.

9. The composite material of claim 8, wherein the polymer is selected from the group comprising polypropylene, polyamide, poly (ethylene terephthalate), acrylonitrile butadiene styrene, and polycarbonate.

10. The composite material of claim 8, wherein the paint sludge is automotive paint sludge.

11. The composite material of claim 8, wherein the composite material has a tensile strength greater than or equal to 30 MPa.

12. The composite material of claim 8, wherein the composite material has a density between 0.8 and 1.5 g/cc.

13. The composite material of claim 8, wherein the composite material has a linear burning rate less than 10 mm/min.

14. A method of manufacturing a polymer composite material comprising:
drying a paint char material;
mixing the paint char material with a polymer; and
compounding the mixture of paint char material and polymer.

15. The method of claim 14, wherein the polymer is selected from the group comprising polypropylene, polyamide, poly (ethylene terephthalate), acrylonitrile butadiene styrene, and polycarbonate.

16. The method of claim 14, wherein the paint char material comprises a pyrolyzed paint sludge.

17. The method of claim 14, wherein the paint char material comprises a pyrolyzed mixture of paint sludge and lignin.

18. The method of claim 17, wherein the paint char material comprises a pyrolyzed automotive paint sludge.

19. The method of claim 14, wherein the composite material has a linear burning rate less than 10 mm/min.

20. The method of claim 14, wherein the composite material is 5-30 wt % paint char.
